(19) United States
(12) Patent Application Publication
(10) Pub. No.: US 2003/0069139 A1
(43) Pub. Date: Apr. 10, 2003

(54) Agrochemical compositions

(76) Inventors: Mahroussa Auda, Siont Denijs Westrem (BE); Frank Dirk Jozef Hartmann, Wilmington, DE (US); Steven Irene Jozef Reekmans, Brussels (BE)

Correspondence Address: Pillsbury Madison & Sutro LLP, Ninth Floor, 1100 New York Avenue, N.W., Washington, DC, 20005-3918, US

(21) Appl. No.: 10/100,171

(22) Filed: Mar. 19, 2002

Related U.S. Application Data
(63) Continuation of application No. 09/541,036, filed on Mar. 31, 2000, now abandoned.
Application No. 09/541,036 is a continuation of application No. PCT/GB98/02951, filed on Oct. 1, 1998.

(30) Foreign Application Priority Data
Oct. 2, 1997 (GB) 9720891.2

(51) Int. Cl. A01N 57/18

(52) U.S. Cl. 504/206

(57) ABSTRACT

Adjuvants for aqueous agrochemical compositions incorporating hydrocarbyl polysaccharides can be formulated with polyalkylene glycols, particularly polyethylene glycols, without a major loss of effectiveness in the total formulation. The compositions can include other water soluble or dispersible non-ionic surfactants. The agrochemical compositions can be used to kill or inhibit vegetation where the agrochemical includes a growth regulator and/or herbicides, particularly water soluble herbicides, such as a glyphosate type herbicides; or to kill or inhibit plant pests where the agrochemical includes a pesticide, particularly an insecticide, fungicide and/or acaricide.

This invention relates to agrochemical compositions and to adjuvant compositions for agrochemical compositions including alkyl saccharide surfactants. It further relates to the use of such adjuvant compositions in agrochemical compositions especially compositions containing growth regulators, herbicides, insecticides, fungicides or acaricides, particularly for spray application.

Hydrocarbyl saccharide surfactants are known materials in which a hydrocarbyl group, typically an alkyl group, is attached to a saccharide residue by an ether bond. The saccharide residue often either is or contains more than one saccharide unit and this class of surfactant is often referred to as being hydrocarbyl (alkyl) polysaccharides. As the number of saccharide repeat residues is not usually very large, often containing low levels of chains having more than 4 saccharide units and typically having an average number of between 1 and 2, describing such materials as polysaccharides is something of a misnomer, although the terminology survives widely in the art. We use the term hydrocarbyl (or alkyl) saccharide to refer to this class of surfactant.

Hydrocarbyl saccharide surfactants are effective adjuvants for agrochemical, particularly growth regulator and/or pesticide active compounds, particularly for glyphosate type herbicides and their use in this way is described in EP 0220902 A. Formulations additionally including other, particularly non-ionic, surfactants are described in EP 0671967 A (WO 94/12259 A) and such other surfactants can contribute to the adjuvancy in the overall system. Typically hydrocarbyl saccharides are used as adjuvants (particularly in end use spray formulations) in solution in water. The present invention is based on our discovery that by using relatively low molecular weight polyethylene glycols (PEGs) as a component of the adjuvant system, the overall amount of hydrocarbyl saccharide used can be reduced without loss of adjuvant activity. This is very surprising because PEGs are not in themselves surfactants and are not recognised as adjuvants and would thus be expected simply to dilute the effectiveness of the hydrocarbyl saccharides.

Accordingly, the present invention provides a composition which comprises

i at least one hydrocarbyl polysaccharide;

ii at least one polyalkylene, particularly at least one polyethylene, glycol; and

iii water.

The invention further includes a water dispersible and/or soluble agrochemical composition comprising

i at least one hydrocarbyl polysaccharide,

ii at least one polyalkylene, particularly at least one polyethylene, glycol;

iii water; and

iv at least one agrochemical.

In this aspect of the invention, the agrochemical is typically one or more plant growth regulators, herbicides, and/or pesticides, for example insecticides, fungicides or acaricides The invention is particularly applicable to water soluble agrochemicals and especially to such agrochemicals that form aqueous solutions of high ionic strength. Notable examples of such agrochemicals are the glyphosate type of herbicide. The invention accordingly includes an agrochemical composition which is dispersible in water and is itself a stable homogeneous aqueous solution comprising:

i at least one hydrocarbyl polysaccharide;

ii at least one polyalkylene, particularly at least one polyethylene, glycol;

iii water; and

iv at least one glyphosate type herbicide.

The composition can include other surfactants, particularly non-ionic surfactants so that the invention further includes a composition which comprises

i at least one hydrocarbyl polysaccharide;

ii at least one polyalkylene, particularly at least one polyethylene, glycol; and

iii water, and

iv at least one other water soluble or water dispersible non-ionic surfactant.

The main reason for including such other water soluble or water dispersible non-ionic surfactants is for their contribution to overall adjuvancy in agrochemical compositions The invention thus includes a water dispersible and/or soluble agrochemical composition comprising:

i at least one hydrocarbyl polysaccharide;

ii at least one polyalkylene, particularly at least one polyethylene, glycol;

iii water;

iv at least one other water soluble or water dispersible non-ionic surfactant; and

v at least one agrochemical.

This aspect of the invention also applies to water soluble agrochemicals that form aqueous solutions of high ionic strength, particularly glyphosate type herbicides and the invention accordingly further includes an agrochemical composition which is dispersible in water and is itself a stable homogeneous aqueous solution comprising:

i at least one hydrocarbyl polysaccharide;

ii at least one polyalkylene, particularly at least one polyethylene, glycol,

iii water;

iv at least one other water soluble or water discernable non-ionic surfactant; and

v at least one glyphosate type herbicide.

The invention includes methods of use of the adjuvant and agrochemical compositions of the invention specifically a method of treating vegetation by applying to plants and/or soil near the plants an agrochemical formulation according to the invention. More particularly, the invention includes the use of agrochemical compositions including adjuvant compositions of this invention in the control of pests and of plant growth. Accordingly, the invention includes:

(i) a method of killing or inhibiting vegetation by applying to the vegetation or the soil near or surrounding the vegetation an agrochemical composition of the invention where the agrochemical is or includes one or more growth regulators and/or herbicides, particularly including at least one glyphosate type herbicide; and/or

(ii) a method of killing or inhibiting plant pests by applying to the vegetation or the soil surrounding the vegetation an agrochemical composition of the invention where the agrochemical is or includes one or more pesticides, for example insecticides, fungicides or acaricides.

The hydrocarbyl saccharide is typically at least one compound of the formula:

ROGₐ

where

R is a hydrocarbyl group;

G is a saccharide residue; and

a is an average value which is at least 1.

R can be a substituted or unsubstituted hydrocarbyl group, such as a cycloalkyl, aryl, alkaryl, aralkyl or alkenyl or, and preferably, an alkyl group, and suitably contains from 4 to 30, more usually up to 24, particularly from 6 to 18, especially 8 to 14, carbon atoms. Particularly as the compounds providing the group R are typically derived from natural products or distillation cuts, R can be a mixture of alkyl groups as described above and which may contain, on average, for example 8 to 14 carbon atoms. Deliberate mixtures of alkyl groups can also be used.

The saccharide residue G can particularly be a glycoside and especially a glycoside residue. Thus it may be derived from one more of fructose, glucose, mannose, galactose, telose, gulose, allose, altrose, idose, arabinose, xylose, lyxose and ribose or from mixtures thereof. The group G is particularly conveniently derived from glucose units and the saccharide is then a glucoside. If derived from sucrose the groups will comprise fructose and glucose residues

The value of a is the degree of polymerisation of the hydrocarbyl (poly)saccharide and as it is an average, it may and often will be non-integral. It is usually greater than 1, typically at least 1.1, desirably at least 1.2, particularly at least 1.3, and is typically not greater than 8, more usually not greater than 4, for example not greater than 2. In particular, when the saccharide is an alkyl glucoside, a is conveniently between 1 and 2. We have obtained useful results using alkyl glucosides of the general formula:

R′O(C₆H₁₀O₅)_{a′}H

where

R′ is a C₈ to C₁₄ alkyl group; and

a′ is between 1 and 2, preferably from about 1.3 to about 1.9.

In particularly useful alkyl glucosides R is a C₉ to C₁₃, particularly about C₁₀, alkyl group, or a mixture of alkyl groups having an average carbon chain length in this range and in an especially useful alkyl glucoside R′ is about C₁₀ alkyl from mixed C₈ to C₁₁ alkyl groups and a′ is about 1.3 to about 1.9.

Hydrocarbyl glycosides are commercially available materials designated for example as Atplus 452, Atplus 508 from ICI Surfactants or as sold under the trade name Triton BG 10 by Rohm & Haas.

The polyalkylene glycols used are desirably polyethylene glycols (PEGs), polypropylene glycols or co-poly(ethylene/propylene) glycols. Generally the glycols have a molecular weight of from about 200 and usually not more than about 2000, more usually from about 250 to about 1000 When polyethylene glycol(s) are used they typically have molecular weights of from about 200 up to about 2000, more usually from about 250 to about 1000, and particularly not more than about 800 These molecular weight ranges correspond to numbers of repeat units (n) in the PEG chain of about 4 to about 45, more usually about 5 to about 22 and preferably not more than about 18. Particularly useful PEGs are those with molecular weights in the range 250 to 600 (n=about 5 to about 16), especially about 300 to about 400 (n=about 6.5 to about 8.5). For ease of handling it is desirable to use liquid PEGs and this corresponds (depending on ambient temperature and method of manufacture) to PEGs having molecular weights not more than about 800. Polypropylene glycols can have similar molecular weights, but more usually will not have molecular weights as high as those possible with polyethylene glycols. Typically molecular weights will be in the range 200 to 600, especially about 250 to about 400.

The weight ratio of hydrocarbyl saccharide to polyalkylene glycol, particularly PEG, used is desirably in the range of about 20 1 to 1 2 Proportions of polyalkylene glycol, particularly PEG, lower than about 20:1 are not significantly more economic than the hydrocarbyl saccharide itself. Increasing the proportion of polyalkylene glycol, particularly PEG, above about 1:1 results in diminished performance at constant adjuvant additive use levels. The amount of the adjuvant composition could be increased relative to the agrochemically active components of an end use formulation to restore the performance, but at the cost of reducing or eliminating the economic benefit. Preferred ranges for the ratio of hydrocarbyl saccharide to polyalkylene glycol, particularly PEG, are from about 10:1 to about 1.5:1, particularly from about 5:1 to about 2:1.

Particularly when the agrochemically active components are or include highly ionic components, particularly when glyphosate type herbicides are used, and especially where the concentration of the solutes is high e.g. as in a so-called adjuvant built in concentrate (intended for dilution prior to use) the proportion of polyalkylene glycol, particularly PEG, may be limited if the molecular weight is above about 400, particularly above about 500 in order to maintain compatibility in the concentrate composition. Desirably, in such formulations, the polyalkylene glycol, particularly PEG, has a molecular weight of from about 200 to about 500, particularly about 250 to about 400.

The formulation can include other surfactants and in particular non-ionic surfactants of the formulae:

R¹O(X)R²

and/or

R³—N(—XH)₂

in which

R¹ is a C₈ to C₁₈ alkyl, (C₆ to C₁₂ alkyl) alkyl phenyl, a sorbitan or a C₁₀ to C₂₂ fatty acyl group;

R² is hydrogen or an alkyl or carboxyalkyl group or a salt thereof, or a C₁₀, to C₂₂ fatty acyl group;

X is a polyalkylene oxide group having an average of 2 to 40 alkylene oxide groups or mixed polyalkylene oxide groups, and

R³ is a C₁₀ to C₂₂ alkyl or alkenyl group.

Preferred non-ionic surfactants of these formulae include those in which

R¹ is a C₁₂ to C₁₅ alkyl group, or a sorbitan group,

R² is hydrogen, a C₁ to C₄ alkyl, or a carboxymethyl group or a salt thereof, or a C₁₀ to C₂₂ fatty acyl group;

X is a polyalkylene oxide, particularly polyethylene or polypropylene oxide, group having an average of 3 to 30 alkylene oxide residues or mixed polyalkylene oxide, particularly mixed polyethylene or polypropylene oxide, group, containing 2 to 25, and preferably 3 to 20 alkylene oxide residues, and

R³ is a C₁₆ to C₁₈ alkyl or alkenyl group

Examples of preferred non-ionic surfactants thus include poly(alkoxylated) C₈ to C₂₄, preferably C₁₂ to C₁₈ fatty acids and alcohols; sorbitan and sorbitol esters, e.g sorbitan monolaurate and monooleate; poly(alkoxylated) derivatives of sorbitan and sorbitol esters; and poly(alkoxylated) fatty amines; and combinations of two or more such compounds. Among poly(alkoxylated) alcohols, polyethoxylates of alcohols with C₁₂ to C₁₈ straight chain alkyl and primary monobranched groups are particularly useful and among poly(alkoxylated) fatty amines, tallow amine ethoxylates are particularly useful, because they can be incorporated into concentrate compositions which are stable and homogeneous aqueous solutions. Ethoxylated sorbitan esters, particularly the oleate and stearate, e.g. the materials sold by ICI under the trade name Tween, are useful, but do not readily form stable homogeneous aqueous solution concentrate compositions and are thus useful primarily as additives when making up the final mix for spraying i.e. as so called “tank mix additives”.

The amount of any other non-ionic surfactant used can vary widely up to about 1.5 times the weight amount of alkyl glycoside used. Typically, the amount, when used, will be from 5% to 120%, more usually from 5 to 100%, by weight of the alkyl glycoside. Generally the total of any other non-ionic surfactant and the polyalkylene glycol will not exceed 150% of the weight of the alkyl glycoside used.

In adjuvant compositions of the invention, the weight ranges of composition will usually be in the following ranges:

| | Range | | | |
|---|---|---|---|---|
| Component | Broad (wt %) | | Narrow (wt %) | |
| Hydrocarbyl (particularly alkyl) | 25 | 70 | 35 | 70 |
| saccharide | | | | |
| PAG (particularly PEG) | 2 | 35 | 5 | 30 |
| Other non-ionic surfactant | 2 | 35 | 5 | 30 |
| (when present) | | | | |
| Minor components | 0 | 5 | 0 | 5 |
| Water | 15 | 70 | 20 | 60 |

The agrochemical used in this invention is typically one or more plant growth regulators, herbicides, and/or pesticides, for example insecticides, fungicides or acaricides. Particular agrochemicals which can be used in this invention include glyphosate type herbicides which are typically compounds of the formula

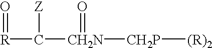

in which

R is halogen, —NHOH, —N(R¹)₂, —OR₂, —SR₂ or —OM,

where each R¹ is independently hydrogen, or an alkyl, hydroxyalkyl, or alkenyl group, preferably containing up to about 5 carbon atoms or a phenyl group;

each R² is independently hydrogen, or an alkyl, hydroxyalkyl, chloroalkyl, or alkoxy group, preferably containing up to about 5 carbon atoms, an alkylene amine group, preferably containing up to about 12 carbon atoms, or a phenyl or benzyl group;

M is hydrogen or an agriculturally acceptable salt forming moiety, such as alkali or alkaline earth metal, or a stannic, ammonium, organic ammonium, alkyl sulfonium, alkyl sulfoxonium, or alkyl phosphonium moiety or a combination thereof; and

Z is hydrogen, an organic moiety or an inorganic moiety.

Such compounds are described in U.S. Pat. Nos. 3,799,758, 4,397,676, 4,140,513, 4,315,765, 3,868,407, 4,405,531, 4,481,026, 4,414,158, 4,120,689, 4,472,189, 4,341,549 and 3,948,975 and, where Z is other than hydrogen, U.S. Pat. Nos. 3,888,915, 3,933,946, 4,062,699, 4,119,430, 4,322,239 and 4,084,954. In preferred compounds, Z is hydrogen or an organic substituent. Suitable organic substituents include methylene carboxylic; methylene phosphonic; methylene cyano; carboxyl, such as formyl, acetyl, benzoyl, penfluoroacyl and thiocarbonyl; ethylene, such as cyano, carbamoyl or carboxy substituted ethyl; and benzene sulphonyl substituents. Patents disclosing compounds where the nitrogen contains three organic substituents Include U.S. Pat. Nos. 3,455,675, 3,556,762, 3,853,530, 3,970,695, 3,988,142, 3,991,095, 3,996,040, 4,047,927, 4,180,394, 4,203,756, 4,261,727 and 4,312,662. A preferred tertiary nitrogen substituted compound is N,N-bis(phosphonomethyl)glycine. Compounds where Z is hydrogen are particularly desirable when the phytoactivity desired is herbicidal activity.

Agriculturally acceptable salt forming moieties represented by M, as in OM, include alkali metals particularly sodium, potassium, or rubidium; alkaline earth metals particularly magnesium or calcium; ammonium and aliphatic ammonium, wherein the aliphatic is primary, secondary, tertiary or quaternary and preferably where the total number of carbon atoms is not more than about 12, phenylammonium; trialkylsulphonium, preferably where the total number of carbon atoms in the three alkyl substituents is not more than about 6, such as trimethylsulphonium, ethyl dimethylsulphonium, propyl dimethylsulphonium and the like, trialkylsulpnoxonium, preferably where the total number of carbon atoms in the three alkyl substituents is not more than about 6, such as trimethylsulphoxonium, ethyl dimethylsulphoxonium, propyl dimethylsulfoxonium and the like, tetraalkylphosphonium, such as tetramethylphosphonium, ethyl trimethylphosphonium, propyl trimethylphosononium and the like

In preferred formulations according to this invention, M is independently an agriculturally acceptable salt forming moieties e.g. as described above or hydrogen, particularly alkali metal, ammonium, monoalkyl ammonium or trialkylsulphonium. In particularly desirable formulations one M is an alkali metal, ammonium, monoalkyl ammonium, or trialkylsulphonium moiety, and the other two are hydrogen. Such particularly desirable compounds include iso-propylamine N-phosphonomethylglycine, trimethylsulphonium N-phosphonomethylglycine and sodium sesqui-N-phosphonomethylglycine. Combinations of two or more such compounds can be used in this invention.

Agrochemical compositions are often formulated as concentrates which are intended to be diluted with water immediately before use. The invention includes agrochemical compositions in the form of dilutable concentrates. As embodied in stable aqueous dilutable solutions containing water soluble agrochemicals, the invention relates to such concentrated compositions particularly having concentrations of the various components in the following ranges.

| | |
|---|---|
| Component | Range (g.l⁻¹) |

| | | |
|---|---|---|
| agrochemical | 100 | 500 |
| adjuvant** | 30 | 500 |
| minor components | 0 | 50 |

| | |
|---|---|
| water | remainder |

As embodied by aqueous compositions containing glyphosate type herbicides typical ranges are:

| Component | Range (g.l⁻¹) | | Typical (g.l⁻¹) |
|---|---|---|---|
| glyphosate herbicide expressed as: | | | |
| acid | 100 | 500 | 330 |
| salt used* | 145 | 725 | 450 |
| adjuvant** | 30 | 500 | 240 |
| minor components | 0 | 50 | as needed |

| | |
|---|---|
| water | remainder |

the ratio of glyphosate (as acid):adjuvant being from 10:1 to 1:3 calculated as for sulfosate(=glyphosate trimethylsulphonium salt) here adjuvant includes the hydrocarbyl saccharide, the polyalkylene glycol and any other non-ionic surfactant present.

The invention includes agrochemical concentrate compositions based on glyphosate type herbicides and this forms a specific aspect of the invention which accordingly provides an agrochemical concentrate composition which is dispersible in water and is itself a stable homogeneous aqueous solution comprising:

from 30 to 500 g.l⁻¹ of an adjuvant composition comprising

a at least one hydrocarbyl polysaccharide;

b at least one polyalkylene, particularly at least one polyethylene, glycol,

c optionally at least one other water soluble or water dispersible non-ionic surfactant; and

d water; and

from 100 to 500 g l⁻¹ of at least one glyphosate type herbicide.

In comparison, the concentrations in the spray formulations will be much lower, typically of the order of 100 times e.g. 50 to 1000 times, more dilute. The relative concentrations will generally remain as indicated above. The particular concentration in any specific case will be determined by the user based on the desired dose of agrochemical to be applied and on the volume of spray to be used. The spray volume will depend on the spraying method and equipment used, but using current methods the spray volume will typically be from about 100 to 400 l.ha⁻¹.

The compositions of the invention may also incorporate other components such as antifoams, viscosity modifiers, stabilisers and antimicrobials.

When present the antifoam component is desirably a polysiloxane antifoam agent, e.g. of the formula:

R¹⁰₃SiO—[SiO R¹⁰R¹¹]ₙ—Si R¹⁰₃

in which the groups R¹⁰ are each alkyl, preferably C₁ to C₃ alkyl, especially methyl, groups, and one or more of the groups R¹¹ may be polyalkylene glycol residues and the others as defined for R¹⁰. The value of n is desirably such that the polysiloxanes have a molecular weight of from 1000 to 20000, preferably 5000 to 15000. Examples of suitable polysiloxane antifoams are disclosed in British Patents 1533610 and 1554736. The amount of antifoam used should be sufficient to secure an adequate anti-foaming effect in use and is normally 0 1 to 10% and preferably 0.2 to 6% by weight of the surfactants present in the formulation corresponding to about 0 01 to 5%, particularly 0.02 to 2%, by weight of an adjuvant or agrochemical concentrate and typically 0 0001 to 0.1%, preferably 0 001 to 0.05%, by weight of a spray formulation at end use dilution

Other possible additives in the dispersible and/or soluble concentrate to which this invention relates include non-surfactant materials which are conventionally useful in surfactant formulations, such as viscosity modifiers, stabilisers, and anti-microbials. One class of known viscosity modifier materials of this type includes one or more commercially available water soluble or miscible materials such as gums, e.g. xanthan gums, and/or cellulosics, e.g. carboxy-methyl, -ethyl or -propylcellulose. These are often present, when used e.g. in agrochemical formulations in particular as 0.01 to 5 wt % of a concentrate formulation and correspondingly diluted in a spray formulation at end use dilution.

The agrochemical compositions of the invention can further include a chemical agent which makes the activity of the agrochemical more specific to or selective in the intended use of the composition. The chemical agent can be a phytotoxicity inhibitor, to regulate any herbicidal activity of the concentrate or corresponding dilute formulation, or to make it more selective, e.g. as between graminious and broad-leaved species. Such a second chemical agent may be present as up to 10 wt % of concentrated compositions and typically up to 0.25% of diluted compositions for spraying.

The compositions of the invention can be made relatively straightforwardly, usually by simple mixing of the components. Conveniently, this may be carried out by dissolving the active agrochemical(s) and the surfactants and any other components in water to give either a concentrate for subsequent dilution to end use concentrations or directly at end use concentration e.g. in the spray tank.

Concentrated agrochemical compositions can be converted into spray formulations by dilution with water, typically in an amount of from 10 to 10,000 times the total weight of the agrochemical and adjuvant components e.g. with 30 to 1,000 times the total weight of these components.

The following Examples illustrate the invention. All parts and percentages are by weight unless otherwise stated.

Materials

| | |
|---|---|
| AS1 | aqueous C₈-C₁₁ alkyl saccharide (DP between 1.6 and 1.9) |
| | adjuvant ex ICI (about 70% alkyl saccharide) |
| AS2 | aqueous C₈-C₁₁ alkyl saccharide (DP between 1.2 and 1.5) |
| | adjuvant ex ICI (about 50% alkyl saccharide) |
| PEG 300 | polyethylene glycol average molecular weight about 300 |
| | from ICI |
| PEG 400 | polyethylene glycol average molecular weight about 400 |
| | from ICI |
| Touchdown | Proprietary glyphosate trimethylsulphonium salt herbicide |
| | formulation including alkyl saccharide adjuvant ex Zeneca |
| ETA | conventional ethoxylated tallow amine adjuvant |
| | (95+% active) |
| water | the water used to make up the spray formulations used in |
| | the Examples had a standard hardness of 342 ppm. |

Methods

Test spray formulations of sulfosate herbicide were made by dissolving the various components in water. The sulfosate concentration used was 330 g.l⁻¹ and the adjuvant compositions 240 g.l⁻¹ of adjuvant (alkyl glycoside including PEG). These compositions were diluted to a concentration of 4 95 g l⁻¹ sulfosate (1.5 liters of concentrates composition per 100 liters of spray). Weed control using glyphosate type herbicides was assessed by spraying the diluted herbicide test formulations onto 6 m×2.5 m in 4 replicate sets of test plots in a fallow field. The spray volume used was 200 l.ha⁻¹ corresponding to 3 l.ha⁻¹ of concentrate and 990 g.ha⁻¹ of active sulfosate. The field flora were predominantly grasses with a roughly even spread of some perennial dicotyledon weeds. At the time of application of the test sprays, the field flora included Ranunculus repens (flowering 15 to 30 cm high), Rumex obtusifolius (in seed 30 to 50 cm), Taraxacum officinale (15 to 20 cm flowering), Trifolium repens (15 to 25 cm), Cirsum arvense (20 to 25 cm), Urtica droica (30 to 50 cm) Holcus lanatus (flowering 30 to 40 cm) and Poa trivialis (15 to 20 cm) The weather at application and throughout the test period was dry and sunny and this may have affected the results

Herbicidal activity was assessed by visual estimation of the percentage remaining green foliage after 15 and 28 days after spraying in each test plot compared to the control plots Estimates of the control of growth of the specific species Ranunculus repens (RANRE) and Rumex obtusifolius (RUMOSS) in treated pots as compared with the control plots was also estimated at 15 days after spraying. These data were scored as a percentage.

Comparison formulations included glyphosate type herbicide without any adjuvant, glyphosate type herbicide with alkyl glucoside as adjuvant (without any PEG) and commercial formulations of glyphosate type herbicide (including any built in adjuvants).

### EXAMPLES

Various herbicide formulations were made up as set out in Table 1 below.

TABLE 1

| Ex | Alkyl sacchande | | PEG | | AS:PEG | Other Surfactant | | Application rate | |
|---|---|---|---|---|---|---|---|---|---|
| No | nature | (%) | nature | (%) | ratio | nature | amount | (l.ha⁻¹) | (g.ha⁻¹) |
| C1 | no treatment | | | | | | | | |
| C2 | Touchdown | | | | | | | 3 | 990 |
| C3 | | 100 | — | 0 | — | — | — | 3 | 990 |
| 1 | AS1 | 75 | PEG 300 | 25 | 2.1 | — | — | 3 | 990 |
| 2 | AS1 | 75 | PEG 300 | 20 | 2.8 | ETA | 5 | 3 | 990 |
| 3 | AS2 | 75 | PEG 300 | 25 | 2.1 | — | — | 3 | 990 |

The results of weed control trial using the protocol described above are set out in Table 2 below:

TABLE 2

| | |
|---|---|
| % green weed after: | % control of species: |

| Ex No | 2 weeks | 4 weeks | RANRE | RUMOSS |
|---|---|---|---|---|
| C1 | 100 | 100 | 0 | 0 |
| C2 | 19 | 17.5 | 83 | 27.5 |
| C3 | 22.5 | 22.5 | 85 | 32.5 |
| 1 | 16 | 26 | 83 | 22.5 |
| 2 | 21 | 27.5 | 87 | 37.5 |
| 3 | 19 | 20 | 78 | 50 |

1. A composition which comprises
i at least one hydrocarbyl polysaccharide;
ii at least one polyalkylene glycol; and
iii water.

2. A composition as claimed in claim 1 in the form of a water dispersible and/or soluble agrochemical composition comprising:
i at least one hydrocarbyl polysaccharide;
ii at least one polyalkylene glycol;
iii water; and
iv at least one agrochemical.

3. A composition as claimed in claim 2 in the form of an agrochemical composition which is dispersible in water and is itself a stable homogeneous aqueous solution comprising:
i at least one hydrocarbyl polysaccharide;
ii at least one polyalkylene glycol;
iii water; and
iv at least one glyphosate type herbicide.

4. A composition as claimed in claim 1 which includes at least one other water soluble or water dispersible non-ionic surfactant.

5. A composition as claimed in claim 1 wherein the hydrocarbyl polysaccharide is at least one at least one compound of the formula:
ROGₐ
where
R is a hydrocarbyl group;
G is a saccharide residue; and
a is an average value which is at least 1.

6. A composition as claimed in claim 5 wherein the hydrocarbyl polysaccharide is at least one glucoside compound of the formula:
R′O(C₆H₁₀O₅)_{a′}H
where
R′ is a C₈ to C₁₄ alkyl group; and
a′ is between 1 and 2.

7. A composition as claimed in claim 1 wherein the polyalkylene glycol is or includes at least one polyethylene glycol, polypropylene glycol or co-poly(ethylene/propylene) glycol.

8. A composition as claimed in claim 7 wherein the polyalkylene glycol is or includes polyethylene glycol having a molecular weight of from about 200 up to about 2000.

9. A composition as claimed in claim 8 wherein the polyethylene glycol has a molecular weight of from about 200 to about 500.

10. A composition as claimed in claim 1 wherein the weight ratio of hydrocarbyl saccharide to polyalkylene glycol is in the range of about 20:1 to 1:2.

11. A composition as claimed in claim 10 wherein the polyalkylene glycol is polyethylene glycol and the weight ratio of hydrocarbyl saccharide to polyethylene glycol is about 10:1 to about 1.5:1.

12. A composition as claimed in claim 1 wherein the composition includes at least one other non-ionic surfactant of the formulae:
R¹O(X)R²
and/or
R³—N(—XH)₂
in which
R¹ is a C₈ to C₁₈ alkyl, alkyl phenyl, a sorbitan or a C₁₀ to C₂₂ fatty acyl group;
R² is hydrogen or an alkyl or carboxyalkyl group or a salt thereof, or a C₁₀ to C₂₂ fatty acyl group;
X is a polyalkylene oxide group having an average of 2 to 40 alkylene oxide groups or mixed polyalkylene oxide groups, and
R³ is a C₁₀ to C₂₂ alkyl or alkenyl group.

13. A composition as claimed in claim 12 wherein the amount of the other non-ionic surfactant is from 5% to 120% by weight of the alkyl glycoside.

14. A composition as claimed in claim 1 which is an agrochemical adjuvant formulation wherein the proportions of the components are:
i hydrocarbyl polysaccharide 25 to 70%;
ii at least one polyalkylene glycol 2 to 35%; and
iii water 15 to 70%;
iv other non-ionic surfactant (when present) 2 to 35; and
v other (minor) components 0 to 5%;
the percentages being by weight based on the total of components i to v.

15. A composition as claimed in claim 1 formulated as a dilutable agrochemical concentrate and which contains:
a agrochemical at a concentration of from 100 to 500 g.l⁻¹;
b adjuvant, being the combination of hydrocarbyl polysaccharide, polyalkylene glycol and other non-ionic surfactant (when present), 30 to 500 g.l⁻¹;
c minor components 0 to 50 g.l⁻¹; and
d the remainder as water.

16. A method of killing or inhibiting vegetation by applying to the vegetation or the soil near or surrounding the vegetation an agrochemical composition including one or more growth regulators and/or herbicides in combination with a composition as claimed in claim 1.

17. A method as claimed in claim 16 wherein the agrochemical is or includes at least one glyphosate type herbicide.

18. A method of killing or inhibiting plant pests by applying to vegetation or the soil surrounding the vegetation an agrochemical composition including one or more pesticides in combination with a composition as claimed in claim 1.

19. A method as claimed in claim 18 wherein the agrochemical is or includes at least one insecticide, fungicide and/or acaricide.

20. A method as claimed in claim 16 wherein the agrochemical composition is spayed onto the vegetation at a rate of about 100 to 400 l.ha⁻¹.
